(19) United States
(12) Patent Application Publication
(10) Pub. No.: US 2018/0203552 A1
(43) Pub. Date: Jul. 19, 2018

(54) DISPLAY SCREEN AND DISPLAY DEVICE

(71) Applicant: Wuhan China Star Optoelectronics Technology Co., Ltd., Wuhan, Hubei (CN)

(72) Inventors: Yao-li HUANG, Shenzhen, Guangdong (CN); Xinglong HE, Shenzhen, Guangdong (CN)

(73) Assignee: Wuhan China Star Optoelectronics Technology Co.,Ltd., Wuhan, Hubei (CN)

(21) Appl. No.: 15/301,280

(22) PCT Filed: Aug. 31, 2016
(86) PCT No.: PCT/CN2016/097529

§ 371 Date: Sep. 30, 2016

(30) Foreign Application Priority Data
Aug. 8, 2016 (CN) 201610642446.3

(51) Int. Cl. G06F 3/041; G06F 3/044; G02F 1/1335; G02F 1/1333; G02F 1/1345

(52) U.S. Cl. CPC G06F 3/0412; G06F 3/044; G06F 3/0414; G02F 1/1345; G02F 1/133512; G02F 1/13338; G02F 1/133514

(57) ABSTRACT

Disclosed is a display screen includes a display panel including a displaying material layer; a force detection layer formed on a light exiting side of the displaying material layer; an insulation layer formed on a side of the force detection layer that is distant from the displaying material layer; a force sensing layer formed on a side of the insulation layer that is distant from the force detection layer, where the force detection layer, the insulation layer, and the force sensing layer collectively form a detection capacitor, which is connected to a force control chip; and a touch panel formed on a side of the force sensing layer that is distant from the insulation layer. The display screen has high sensitivity for force detection. Also disclosed is a display device.

### CROSS REFERENCE TO RELATED APPLICATIONS

This application claims the priority of Chinese Patent Application No. 201610642446.3 filed on Aug. 8, 2016, titled “Display Screen and Display Device”, the disclosure of which is incorporated herein by reference in its entirety.

### FIELD OF THE INVENTION

The present invention relates to the field of display technology, and more particularly to a display screen and a display device.

### BACKGROUND OF THE INVENTION

A display screen of a conventional liquid crystal display (LCD) provides a sole function of displaying. An externally mounted touch panel (TP) must be generally provided on the side of a display panel of the display screen from which light exits in order to achieve an additional force contact function, and also, an externally mounted force touch unit must be arranged on the side of the display panel that is opposite to the lighting side.

The touch unit is generally composed of a force detection layer and a force sensing layer that are isolated from each other and are very close to each other. The force detection layer, the force sensing layer, and an insulation layer (such as an air layer) arranged therebetween collectively form a detection capacitor. Thus, the force touch unit is in fact a capacitive detection unit. It is common to use an intermediate frame (made of a metallic material) of a mobile terminal (such as a mobile phone) to serve as a force sensing layer in the known force touch units, while the force detection layer can be: a conductive pattern formed with a copper foil layer of a flexible circuit board or a conductive pattern formed on a polyethylene terephthalate (PET) substrate through screen-printing of silver paste. Before a use depresses the display screen, the force touch unit exhibits a capacitance C; and when the user presses the display screen, a gap between the force detection layer and the force sensing layer varies so that the force touch unit exhibits a capacitance C′. The magnitude of the force can be determined by detecting the variation between the capacitances C and C′.

However, since the force touch unit is arranged on the side of the display panel that is opposite to the lighting side, a user must apply a relative large force in order to make it possible to simultaneously depress the touch panel and the display panel to such an extent of being deformed and then, the force touch unit may detect the variation of capacitance. Consequently, it is hardly possible for the force touch unit to detect a small force and thus, force detection of the display screen is generally not sensitive enough.

### SUMMARY OF THE INVENTION

The technical issue to be addressed by the present invention is to provide a display screen, which has high force detection sensitivity and a display device that uses the display screen.

To achieve the above object, the present invention adopts the following technical solutions:

In an aspect, a display screen is provided, comprising:

a display panel, which comprises a displaying material layer;

a force detection layer, which is formed on a light exiting side of the displaying material layer;

an insulation layer, which is formed on a side of the force detection layer that is distant from the displaying material layer;

a force sensing layer, which is formed on a side of the insulation layer that is distant from the force detection layer, wherein the force detection layer, the insulation layer, and the force sensing layer collectively form a detection capacitor, the detection capacitor being adapted to connect to a force control chip; and

a touch panel, which is formed on a side of the force sensing layer that is distant from the insulation layer.

In the above display screen, the force sensing layer is arranged grounded and the force detection layer comprises connection terminals and a plurality of mutually spaced detection blocks, the plurality of detection blocks being connected through lead wires to the connection terminals, the connection terminals being electrically connectable to the force control chip.

In the above display screen, the insulation layer comprises an air layer or a vacuum layer, the air layer or the vacuum layer being formed between the display panel and the touch panel.

In the above display screen, the force sensing layer comprises a layer of an indium tin oxide material covering an entire surface thereof, the plurality of detection blocks being formed of an indium oxide material.

In the above display screen, the displaying material layer comprises a liquid crystal layer and the display panel further comprises a color filter substrate located at a light exiting side of the liquid crystal layer, the force detection layer being formed on a side of the color filter substrate that is distant from the liquid crystal layer.

In the above display screen, the displaying material layer comprises a liquid crystal layer and the display panel further comprises a color filter substrate located at a light exiting side of the liquid crystal layer, the force detection layer being formed between the color filter substrate and the liquid crystal layer.

In the above display screen, the color filter substrate comprises a black matrix and a displaying matrix that are arranged alternately, a gap being formed between any two adjacent ones of the detection blocks of the force detection layer, the gaps being arranged to exactly correspond to the black matrix.

In the above display screen, the displaying material layer comprises a liquid crystal layer and the display panel further comprises a color filter substrate located at a light exiting side of the liquid crystal layer, the color filter substrate comprising a substrate and a filter layer arranged between the liquid crystal layer and the substrate, the force detection layer being formed between the substrate and the filter layer.

In the above display screen, a gap is formed between any two adjacent ones of the detection blocks of the force detection layer and the filter layer comprises a black matrix and a displaying matrix that are arranged alternately, the gaps being arranged to exactly correspond to the black matrix, the gaps being filled up with the black matrix.

In another aspect, a display device is provided, comprising the display as described above.

Compared to the prior art, the present invention offers the following advantages:

The display screen is integrated with the display panel, the detection capacitor, and the touch panel so that the display screen possesses a touch display function. Further, since the detection capacitor is formed between the displaying material layer and the touch panel, it only needs a small force applied by a user to cause deformation of the touch panel and the force sensing layer, so as to cause variation of a spacing distance between the force sensing layer and the force detection layer thereby making the capacitance of the detection capacitor changed. The force control chip may calculate the magnitude of the force applied to the detection capacitor. Thus, the display screen can detect the force for a large range of magnitude and may particularly improve capability for detection of small forces and the detection can be carried out quickly and correctly. The display screen has high force detection sensitivity.

In addition, the detection capacitor according to the embodiment uses an idle space of a conventional touch display screen (namely a space formed between the display panel and the touch panel of the touch display screen) so as to reduce the thickness of the display screen and thus, make it possible for a mobile terminal in which the display screen is involved to be made compact and light-weighted.

Further, since the force detection layer is formed on the light exit side of the displaying material layer, the force detection layer may serve as a shielding layer, providing the display panel with effectiveness of resistance against static electricity and electromagnetic interference.

### BRIEF DESCRIPTION OF THE DRAWINGS

To more clearly explain the technical solution proposed in the present invention, a brief description of the drawings that are necessary for embodiments is given as follows. It is obvious that the drawings that will be described below show only some embodiments of the present invention. For those having ordinary skills of the art, other drawings may also be readily available from these attached drawings without the expense of creative effort and endeavor.

FIG. 1 is a schematic view illustrating a display screen provided according to an embodiment of the present invention;

FIG. 2 is a schematic view illustrating a condition where the display screen provided according to the embodiment of the present invention is depressed;

FIG. 3 is a schematic view illustrating a force detection layer of the display screen provided according to the embodiment of the present invention;

FIG. 4 is a schematic view illustrating a display screen provided according to another embodiment of the present invention; and

FIG. 5 is a schematic view illustrating a display screen provided according to a further embodiment of the present invention.

### DETAILED DESCRIPTION OF THE PREFERRED EMBODIMENTS

A clear and complete description will be given to a technical solution of an embodiment of the present invention with reference to the attached drawings of the embodiment of the present invention. However, the embodiments so described are only some, but not all, of the embodiments of the present invention. Other embodiments that are available to those having ordinary skills of the art without the expense of creative effort and endeavor are considered belonging to the scope of protection of the present invention.

Further, the following descriptions of the various embodiments are made with reference to the attached drawings for illustrating, in an exemplary way, specific embodiments to which the present invention is applicable. Directional terminology, such as “up”, “down”, “front”, “rear”, “left”, “right”, “internal”, “external”, and “side”, used in the present invention are described according to the direction shown in the drawings and are not intended to indicate or suggest a designated device or element must be of a specific direction or be constructed or operated in a specific direction and thus they should not be construed as constraint to the scope of the present invention.

In the description of the present invention, it is noted that unless explicitly specified or constrained, the terms “mounting”, “interconnecting”, “connecting”, and “disposed on” should be interpreted as fixed connection and may alternatively be releasable connection or integral connection; or being mechanically connected; or in direction connection with each other or interconnected through an intermediate medium; or being communication between interiors of two elements. For those having ordinary skills in the art can appreciate the meaning of these terms as used in the present invention in specific conditions.

Further, unless specified otherwise, in the description of the present invention, “plural” means two or more than two. The term “operation”, when appearing in the specification, does not just include an independent operation and may also include a desired effect of the operation achieved with the operation when the operation is not distinguishable from other operations. The symbol “-” used in the present invention to define a numeric range, of which the minimum and maximum are respectively corresponding to the figures set in front of and behind of the symbol “-”. In the attached drawings, similar structures or identical units are designated with the same reference numerals.

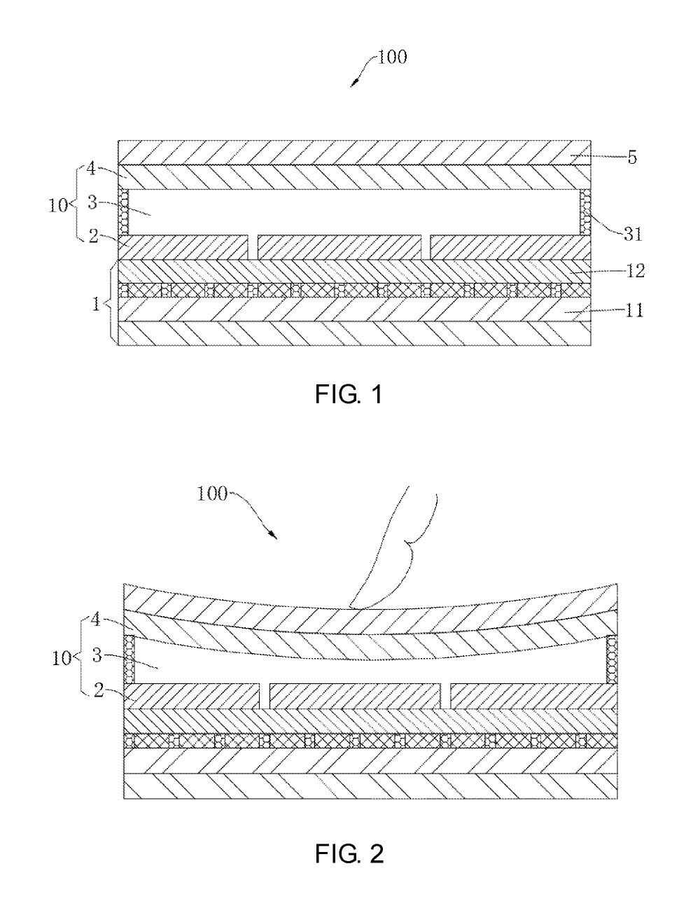

Referring collectively to FIGS. 1-3, an embodiment of the present invention provides a display screen 100, which comprises a display panel 1, a force detection layer 2, an insulation layer 3, a force sensing layer 4, and a touch panel (TP) 5. The display panel 1 comprises a displaying material layer 11. The force detection layer 2 is formed on a light exit side of the displaying material layer 11. The insulation layer 3 is formed on a side of the force detection layer 2 that is distant from the displaying material layer 11. The force sensing layer 4 is formed on a side of the insulation layer 3 that is distant from the force detection layer 2. The force detection layer 2, the insulation layer 3, and the force sensing layer 4 collectively form a detection capacitor 10. The detection capacitor 10 is connected to a force control chip 6 for calculating the magnitude of a force applied to the display screen 100. The touch panel 5 is formed on a side of the force sensing layer 4 that is distant from the insulation layer 3 in order to provide the display screen 100 with a force touch function.

In the instant embodiment, the display screen 100 is integrated with the display panel 1, the detection capacitor 10, and the touch panel 5, so that the display screen 100 possesses a touch display function. Further, since the detection capacitor 10 is formed between the displaying material layer 11 and the touch panel 5, it only needs a small force applied by a user to cause deformation of the touch panel 5 and the force sensing layer 4, so as to cause variation of a spacing distance between the force sensing layer 4 and the force detection layer 2 thereby making the capacitance of the detection capacitor 10 changed. The force control chip 6 may calculate the magnitude of the force applied to the detection capacitor 10. Thus, the display screen 100 can detect the force for a large range of magnitude and may particularly improve capability for detection of small forces and the detection can be carried out quickly and correctly. The display screen 100 has high force detection sensitivity.

In addition, the detection capacitor 10 according to the embodiment uses an idle space of a conventional touch display screen 100 (namely a space formed between the display panel 1 and the touch panel 5 of the touch display screen 100) so as to reduce the thickness of the display screen 100 and thus, make it possible for a mobile terminal in which the display screen 100 is involved to be made compact and light-weighted.

Further, since the force detection layer 2 is formed on the light exit side of the displaying material layer 11, the force detection layer 2 may serve as a shielding layer, providing the display panel 1 with effectiveness of resistance against static electricity and electromagnetic interference.

It is appreciated that, in the instant embodiment, the insulation layer 3 is a deformable layer so that a spacing distance between the force detection layer 2 and the force sensing layer 4 is changeable and the capacitance of the detection capacitor 10 is changeable. Specifically speaking, as shown in FIG. 1, when the display screen 100 receives no external force acting thereon, the capacitance of the detection capacitor 10 is C; and as shown in FIG. 2, when the display screen 100 receives an external force acting thereon, the force sensing layer 4 and the insulation layer 3 undergo deformation and the spacing distance between the force sensing layer 4 and the detection layer changes so that the capacitance of the detection capacitor 10 becomes C′. The force control chip 6 may calculate and determine the magnitude of the force applied according to the change or variation of the capacitance of the detection capacitor 10 from C to C′.

Preferably, the displaying material layer 11 can be one of a liquid crystal layer, an organic light emission layer, the electrophoretic material layer, or other feasible display media, in order to form different types of display panel 1.

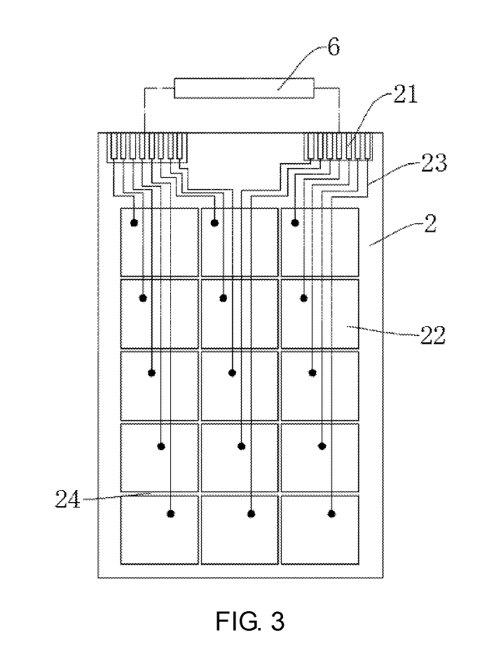

Further, referring collectively to FIGS. 1 and 3, as an optional embodiment, the force sensing layer 4 is arranged grounded and the force detection layer 2 comprises connection terminals 21 and a plurality of mutually-spaced detection blocks 22. The plurality of detection blocks 22 are connected, through lead wires 23, to the connection terminals 21, and the connection terminals 21 are electrically connectable to the force control chip 6.

In the instant embodiment, a number of lead wires 23 are involved and the connection terminals 21 comprise a plurality of golden fingers. The lead wires 23 connect the plurality of detection blocks 22 and the plurality of golden fingers to each other in a one-to-one corresponding manner.

Further, during the use of the display screen 100, since the force detection layer 2 does not undergo deformation, the lead wires 23 and the plurality of detection blocks 22 are prevented from being readily detached or damaged so that the detection capacitor 10 shows excellent operation performance and reliability.

Preferably, the lead wires 23 are formed of a metallic material and the lead wires 23 are arranged to be aligned with a non-display zone of the display panel 1 (such as a black matrix area).

Preferably, the plurality of detection blocks 22 are uniformly distributed in a major area of the display screen 100 and orthogonal projections of the plurality of detection blocks 22 on the detection layer are all within the area or range of the detection layer so that the detection capacitor 10 may detect the magnitudes of forces acting on each of multiple zones of the display screen 100. Preferably, the plurality of detection blocks 22 are arrayed in a rectangle. Or alternatively, the plurality of detection blocks 22 are arranged at a density that is variable according to the requirement for application of the display screen 100, such as a large distribution density at a middle area, while a small distribution density in a peripheral area.

Further, referring collectively to FIGS. 1 and 2, as an optional embodiment, the insulation layer 3 comprises an air layer or a vacuum layer, and the air layer or the vacuum layer is formed between the display panel 1 and the touch panel 5. An air layer has a low cost and an easy manufacturing operation, making it helpful in reducing the cost of the display screen 100. A vacuum layer provides an excellent effect of insulation and is helpful in improving sensitivity and accuracy of the detection capacitor 10.

Preferably, the display screen 100 further comprises support members 31. The support members 31 are connected between the display panel 1 and the touch panel 5 in order to form the air layer or the vacuum layer between the display panel 1 and the touch panel 5. The support members 31 are made of an insulation material.

Of course, in other embodiments, the insulation layer 3 may comprise other deformable insulation materials.

Further, referring collectively to FIGS. 1-3, as an optional embodiment, the force sensing layer 4 comprises a layer of an indium tin oxide material covering an entire surface thereof and the plurality of detection blocks 22 are formed of an indium tin oxide material. Forming the force sensing layer 4 and the plurality of detection blocks 22 with the same material helps reduce the manufacturing cost of the detection capacitor 10 and thus reducing the cost of the display screen 100. Also, a force sensing layer 4 and a plurality of detection blocks 22 that are transparent do not affect normal displaying of the display panel 1.

Further, referring collectively to FIGS. 1-3, as an optional embodiment, the displaying material layer 11 comprises a liquid crystal layer, and the display panel 1 further comprises a color filter substrate 12 formed on a light exiting side of the liquid crystal layer. The force detection layer 2 is formed on a side of the color filter substrate 12 that is distant from the liquid crystal layer.

In the instant embodiment, the plurality of patterned detection blocks 22 of the force detection layer 2 can be directly formed on the color filter substrate 12 so as to save a base layer (such as PET and FPC) involved in a conventional structure for the detection blocks 22 and thus greatly reduce the thickness of the detection capacitor 10 and also lower down the cost. Further, the manufacturing process of the force detection layer 2 can be combined with the manufacturing process of the display panel 1 so as to reduce the assembling cost, improve the integration of the industry, and facilitate simplification of the manufacturing operation of the display screen 100 and lower down the manufacturing cost of the display screen 100.

Similarly, the force sensing layer 4 can be directly formed on the touch panel 5 so as to combine the manufacturing process of the force sensing layer 4 with the manufacturing process of the touch panel 5 to reduce the assembling cost, improve the integration of the industry, and facilitate simplification of the manufacturing operation of the display screen 100 and lower down the manufacturing cost of the display screen 100.

It is appreciated that the above solution is equally applicable to embodiments that involve different displaying media as the displaying material. For example, the displaying material layer 11 can be an organic light emission layer, and the display panel 1 further comprises a substrate located at a light exiting side of the organic light emission layer. The force detection layer 2 is formed on a side of the substrate that is distant from the organic light emission layer.

Preferably, the display screen 100 further comprises a shielding layer and an isolation layer. The shielding layer is formed on a side of the color filter substrate 12 that faces toward the force detection layer 2 to shield external static electricity or electromagnetic interference so that the display panel 1 is provided with an effect of resistance against static electricity and electromagnetic interference. The isolation layer is formed between the shielding layer and the force detection layer 2 to separate the shielding layer and the force detection layer 2. The isolation layer comprises an insulation material.

Preferably, the isolation layer is structured to expose a portion of the shielding layer in order to form a grounding zone of the shielding layer.

Preferably, a surface of the plurality of detection blocks 22 of the force detection layer 2 that faces the insulation layer 3 is coated with a protection layer and a surface of the force sensing layer 4 that faces the insulation layer 3 is coated with a protection layer, so that a better effect of insulation can be formed between the force detection layer 2 and the force sensing layer 4 to improve the operation performance and reliability of the detection capacitor 10.

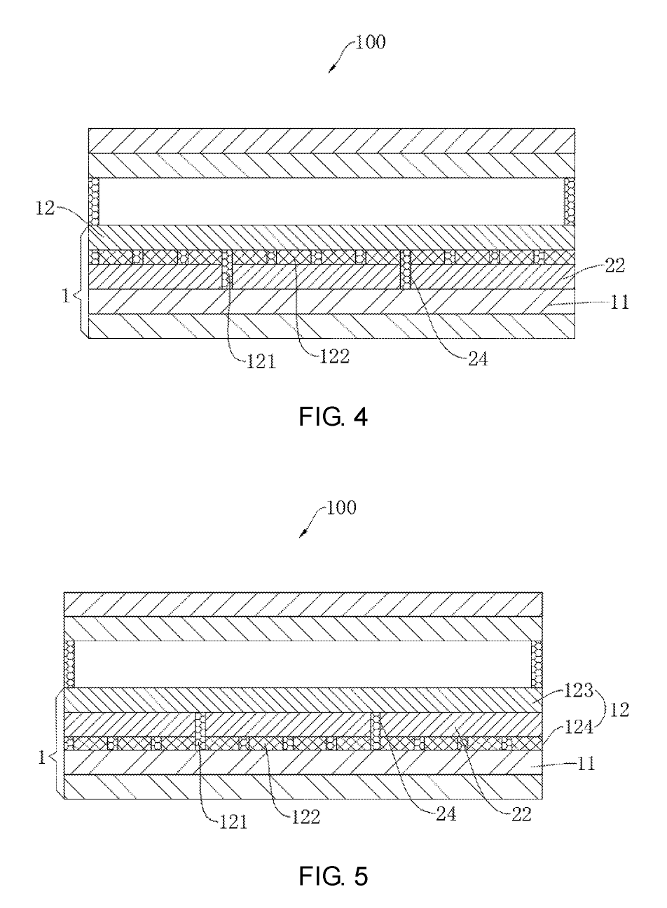

Further, referring collectively to FIGS. 3-4, as an optional embodiment, the displaying material layer 11 can be a liquid crystal layer, and the display panel 1 further comprises a color filter substrate 12 located at a light exiting side of the liquid crystal layer. The force detection layer 2 is formed between the color filter substrate 12 and the liquid crystal layer.

In the instant embodiment, since the force detection layer 2 is formed between the color filter substrate 12 and the liquid crystal layer, the manufacturing process of the force detection layer 2 can be combined with the manufacturing process of the display panel 1 to reduce the assembling cost of the display screen 100, improve the integration of the industry, and facilitate simplification of the manufacturing operation of the display screen 100 and lower down the manufacturing cost of the display screen 100.

Preferably, the color filter substrate 12 comprises a black matrix 121 and a displaying matrix 122 that are arranged alternately. A gap 24 is formed between any two adjacent ones of the detection blocks 22 of the force detection layer 2 and the gaps 24 are arranged to exactly correspond to the black matrix 121. Thus, light emitting from the displaying matrix 122 passes through the plurality of detection blocks 22. The arrangement of the force detection layer 2 does not affect the displaying performance of the display panel 1 and the display screen 100 may have excellent displaying quality.

Further, referring collectively to FIGS. 3-5, as an optional embodiment, the displaying material layer 11 can be a liquid crystal layer, and the display panel 1 further comprises a color filter substrate 12 located at a light exiting side of the liquid crystal layer. The color filter substrate 12 comprises a substrate 123 and a filter layer 124 arranged between the liquid crystal layer and the substrate 123. The force detection layer 2 is formed between the substrate 123 and the filter layer 124.

In the instant embodiment, the force detection layer 2 is formed between the substrate 123 and the filter layer 124 so that the manufacturing process of the force detection layer 2 can be combined with the manufacturing process of the display panel 1 to reduce the assembling cost of the display screen 100, improve the integration of the industry, and facilitate simplification of the manufacturing operation of the display screen 100 and lower down the manufacturing cost of the display screen 100.

Preferably, a gap 24 is formed between any two adjacent ones of the detection blocks 22 of the force detection layer 2 and the filter layer 124 comprises a black matrix 121 and a displaying matrix 122 that are arranged alternately. The gaps 24 are arranged to exactly correspond to the black matrix 121 and the black matrix 121 is filled in the gap 24. Thus, light emitting from the displaying matrix 122 passes firstly through the plurality of detection blocks 22. The arrangement of the force detection layer 2 does not affect the displaying performance of the display panel 1 and the display screen 100 may have excellent displaying quality.

Referring collectively to FIGS. 1-5, an embodiment of the present invention further provides a display device. The display device comprises the display screen 100 described in any one of the above-described embodiments. The display device further comprises the force control chip 6, and the force control chip 6 is operable to calculate and determine the magnitude of a force applied thereto according to variation of capacitance of the detection capacitor 10.

The display device, due to involving the display screen 100, possesses a touch display function and shows high sensitivity of force detection.

Preferably, the force control chip 6 can be integrated with a driving main board of the display panel 1.

The display device is applicable to multiple types of mobile terminals. Such mobile terminals may include, but not limited to, mobile phones, notebook computers, tablet computers, POS devices, car-carrying computers, and cameras.

The above provides a detailed description of an embodiment of the present invention. In the disclosure, reference is made to an example for describing principle and embodiment of the present invention. The illustration of the above embodiment is provided to help understanding of the method and the essential idea of the present invention. Further, based on the idea of the present invention, those having ordinary skills in the field of the art may readily appreciate modifications that can be made in respect of the way of embodiment and the range of application. In brief, the contents disclosed in this specification is not intended to impose undue limitations to the scope of the present invention.

What is claimed is:

1. A display screen, comprising:
a display panel, which comprises a displaying material layer;
a force detection layer, which is formed on a light exiting side of the displaying material layer;
an insulation layer, which is formed on a side of the force detection layer that is distant from the displaying material layer;
a force sensing layer, which is formed on a side of the insulation layer that is distant from the force detection layer, wherein the force detection layer, the insulation layer, and the force sensing layer collectively form a detection capacitor, the detection capacitor being adapted to connect to a force control chip; and
a touch panel, which is formed on a side of the force sensing layer that is distant from the insulation layer.

2. The display screen as claimed in claim 1, wherein the force sensing layer is arranged grounded and the force detection layer comprises connection terminals and a plurality of mutually spaced detection blocks, the plurality of detection blocks being connected through lead wires to the connection terminals, the connection terminals being electrically connectable to the force control chip

3. The display screen as claimed in claim 2, wherein the insulation layer comprises an air layer or a vacuum layer, the air layer or the vacuum layer being formed between the display panel and the touch panel.

4. The display screen as claimed in claim 2, wherein the force sensing layer comprises a layer of an indium tin oxide material covering an entire surface thereof, the plurality of detection blocks being formed of an indium oxide material.

5. The display screen as claimed in claim 2, wherein the displaying material layer comprises a liquid crystal layer and the display panel further comprises a color filter substrate located at a light exiting side of the liquid crystal layer, the force detection layer being formed on a side of the color filter substrate that is distant from the liquid crystal layer.

6. The display screen as claimed in claim 2, wherein the displaying material layer comprises a liquid crystal layer and the display panel further comprises a color filter substrate located at a light exiting side of the liquid crystal layer, the force detection layer being formed between the color filter substrate and the liquid crystal layer.

7. The display screen as claimed in claim 5, wherein the color filter substrate comprises a black matrix and a displaying matrix that are arranged alternately, a gap being formed between any two adjacent ones of the detection blocks of the force detection layer, the gaps being arranged to exactly correspond to the black matrix.

8. The display screen as claimed in claim 6, wherein the color filter substrate comprises a black matrix and a displaying matrix that are arranged alternately, a gap being formed between any two adjacent ones of the detection blocks of the force detection layer, the gaps being arranged to exactly correspond to the black matrix.

9. The display screen as claimed in claim 2, wherein the displaying material layer comprises a liquid crystal layer and the display panel further comprises a color filter substrate located at a light exiting side of the liquid crystal layer, the color filter substrate comprising a substrate and a filter layer arranged between the liquid crystal layer and the substrate, the force detection layer being formed between the substrate and the filter layer.

10. The display screen as claimed in claim 9, wherein a gap is formed between any two adjacent ones of the detection blocks of the force detection layer and the filter layer comprises a black matrix and a displaying matrix that are arranged alternately, the gaps being arranged to exactly correspond to the black matrix, the gaps being filled up with the black matrix.

11. A display device, comprising a display screen, the display screen comprising:
a display panel, which comprises a displaying material layer;
a force detection layer, which is formed on a light exiting side of the displaying material layer;
an insulation layer, which is formed on a side of the force detection layer that is distant from the displaying material layer;
a force sensing layer, which is formed on a side of the insulation layer that is distant from the force detection layer, wherein the force detection layer, the insulation layer, and the force sensing layer collectively form a detection capacitor, the detection capacitor being connected to a force control chip; and
a touch panel, which is formed on a side of the force sensing layer that is distant from the insulation layer.

12. The display device as claimed in claim 11, wherein the force sensing layer is arranged grounded and the force detection layer comprises connection terminals and a plurality of mutually spaced detection blocks, the plurality of detection blocks being connected through lead wires to the connection terminals, the connection terminals being electrically connected to the force control chip.

13. The display device as claimed in claim 12, wherein the insulation layer comprises an air layer or a vacuum layer, the air layer or the vacuum layer being formed between the display panel and the touch panel.

14. The display device as claimed in claim 12, wherein the force sensing layer comprises a layer of an indium tin oxide material covering an entire surface thereof, the plurality of detection blocks being formed of an indium oxide material.

15. The display device as claimed in claim 12, wherein the displaying material layer comprises a liquid crystal layer and the display panel further comprises a color filter substrate located at a light exiting side of the liquid crystal layer, the force detection layer being formed on a side of the color filter substrate that is distant from the liquid crystal layer.

16. The display device as claimed in claim 12, wherein the displaying material layer comprises a liquid crystal layer and the display panel further comprises a color filter substrate located at a light exiting side of the liquid crystal layer, the force detection layer being formed between the color filter substrate and the liquid crystal layer.

17. The display device as claimed in claim 15, wherein the color filter substrate comprises a black matrix and a displaying matrix that are arranged alternately, a gap being formed between any two adjacent ones of the detection blocks of the force detection layer, the gaps being arranged to exactly correspond to the black matrix.

18. The display device as claimed in claim 16, wherein the color filter substrate comprises a black matrix and a displaying matrix that are arranged alternately, a gap being formed between any two adjacent ones of the detection blocks of the force detection layer, the gaps being arranged to exactly correspond to the black matrix.

19. The display device as claimed in claim 12, wherein the displaying material layer comprises a liquid crystal layer and the display panel further comprises a color filter substrate located at a light exiting side of the liquid crystal layer, the color filter substrate comprising a substrate and a filter layer arranged between the liquid crystal layer and the substrate, the force detection layer being formed between the substrate and the filter layer.

20. The display device as claimed in claim 19, wherein a gap is formed between any two adjacent ones of the detection blocks of the force detection layer and the filter layer comprises a black matrix and a displaying matrix that are arranged alternately, the gaps being arranged to exactly correspond to the black matrix, the gaps being filled up with the black matrix.
